(19) United States
(12) Patent Application Publication
(10) Pub. No.: US 2006/0253525 A1
(43) Pub. Date: Nov. 9, 2006

(54) Remote control and delivery of personalized digital content

(76) Inventor: Kirk Matthew Slota, Issaquah, WA (US)

Correspondence Address: PELOQUIN, PLLC, 800 FIFTH AVENUE, SUITE 4100, SEATTLE, WA, 98104-3100, US

(21) Appl. No.: 11/125,393

(22) Filed: May 9, 2005

(51) Int. Cl. G06F 15/16

(52) U.S. Cl. 709/200

(57) ABSTRACT

Methods and apparatuses are described to initiate a network connection between a first device and a second device, wherein a source device is in communication with the first device. The source device is controlled from the second device, wherein an analog or digital content is sent from a source device to the first device. The content from the source device is encoded on the first device and decoded on the second device.

### BACKGROUND OF THE INVENTION

1. Field of Invention

Embodiments of the invention relate generally to digital media content and, more specifically, to apparatuses and methods used to remotely control a source of analog or digital media content and to remotely control the delivery of a digital media content utilizing a communications network.

2. Art Background

Ordinary speech, music, and pictures (whether still or motion) are routinely heard, collected, and viewed by people during the course of life. A person listens to a radio to hear the news, sports, weather, music, etc. A collection of music, for example, can consist of a collection of audio tapes. A collection of pictures can consist of video tapes that are played on a video cassette recorder or a collection can exist based on another type of media.

As technology has progressed, the media used to store music and pictures has changed; 8-track tapes have been followed by cassette tapes which have been followed by compact disks (CDs) and solid state storage on devices known as MP3 players, etc. These devices require a user to be proximately located to the device that is playing the media content in order to hear the music or see the picture(s).

Music and pictures embodied on a carrier wave, such as a television signal, are available for viewing on a variety of channels. Content of this type is distributed with systems, such as cable television distribution systems or a signal containing such content can be received as an electromagnetic transmission (either terrestrial or satellite based) through the air with an antenna at a location where the television set is located.

Modern life places demands on a person's time. Demands resulting from work, such as time spent commuting, can make it impossible for a person to be at a certain place where a media player such as a television is located in order to hear or view the content. This can present a problem. At times and at increased expense, media players are duplicated. For example, a person buys a television set for the home, the office, and the car. Such duplication requires an additional expenditure of money. This can present a problem.

Demands resulting from work, school, friends, and relatives can at times make it difficult for a person to be at a certain place where a particular media player is located in order to hear or see a particular program. This can present a problem.

### BRIEF DESCRIPTION OF THE DRAWINGS

The invention may best be understood by referring to the following description and accompanying drawings that are used to illustrate embodiments of the invention. The invention is illustrated by way of example in the embodiments and is not limited in the figures of the accompanying drawings, in which like references indicate similar elements.

FIG. 1A illustrates remote control and delivery of content to a device, according to various embodiments of the invention.

FIG. 1B shows device architectures, according to various embodiments of the invention.

FIG. 2 illustrates a symmetric architecture for delivery of digital content, according to various embodiments of the invention.

FIG. 3 depicts a process to control a source device, according to embodiments of the invention.

FIG. 4A depicts various functionalities of the user interfaces, according to embodiments of the invention.

FIG. 4B is a continuation of FIG. 4A.

FIG. 5 shows an encoder status monitor, according to embodiments of the invention.

FIG. 6 illustrates a user interface, according to embodiments of the invention.

### DETAILED DESCRIPTION

In the following detailed description of embodiments of the invention, reference is made to the accompanying drawings in which like references indicate similar elements and in which is shown by way of illustration, specific embodiments in which the invention may be practiced. These embodiments are described in sufficient detail to enable those of skill in the art to practice the invention. In other instances, well-known circuits, structures, and techniques have not been shown in detail in order not to obscure the understanding of this description. The following detailed description is, therefore, not to be taken in a limiting sense and the scope of the invention is defined only by the appended claims.

Apparatuses and methods are described for remote control and delivery of personalized content utilizing a communications network.

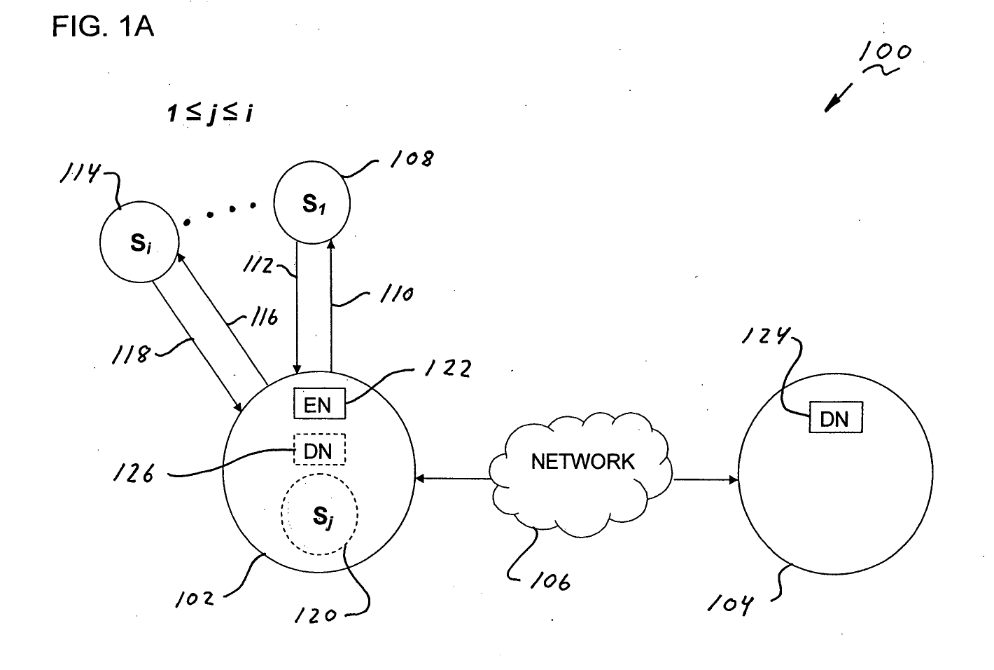

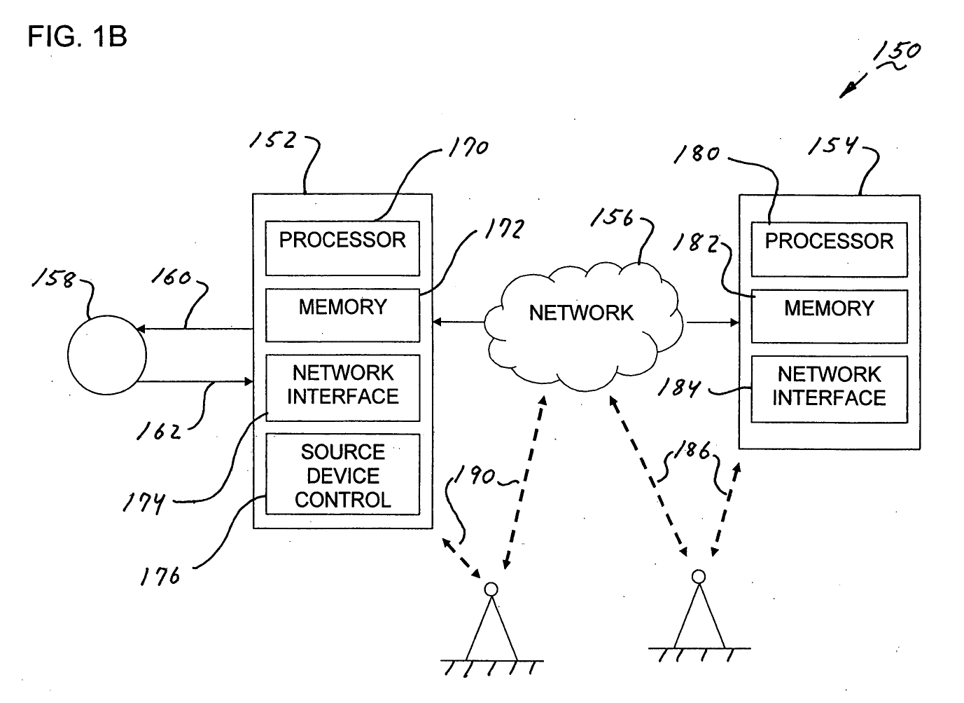

FIG. 1A illustrates remote control and delivery of content to a device, according to various embodiments of the invention, shown generally at 100. With reference to FIG. 1A, a first device 102 is in communication with a second device 104 utilizing a network 106. The network 106 facilitates communication between the two devices (102 and 104). A general number (i) of source devices, such as a first source device represented at 108 up to and including the i^{th} source device represented at 114, is coupled with the first device 102.

The first source device 108 is configured to receive a control signal from the first device 102 across a path 110. The path 110 can be a wireless communication path or a wired communication path. In one embodiment, the path 110 is a wireless communication path that is configured to use a signal in an infra-red portion of the electromagnetic spectrum. Similarly, each of the general number (i) of source devices has a path as indicated at 116. The paths 110 and 116 permit commands to be sent from the first device to the source devices 108 through 114.

A path 112 allows content to flow from the source device 108 to the first device 102. Similarly, each of the general number (i) of source devices has a path as indicated at 118, which allows their respective content to be received by the first device 102. In various embodiments, the device 102 does not have a device driver, such as a resident software device driver, for controlling a source device, such as the source device 108. In some embodiments, the device 102 will have a software device driver, such as a resident software device driver, that is used to control a source device such as the source device 108. In some embodiments, the paths 110 and 112 or 116 and 118 can represent a communication path to a source device utilizing universal serial bus (USB), IEEE 1394 (fire-wire), etc.

In one embodiment, the first device 102 is configured with a processor, a memory, a network interface, and a source device control. In one embodiment, the second device 104 is configured with a processor, a memory, and a network interface. Those of skill in the art will understand that “a memory” as used with respect to the first or second device, can represent one or more mediums used for storage, such as but not limited to, solid state random access memory (RAM), various disk drives, RAM used in conjunction with one or more disk drives, etc. Such a configuration of the first device 102 and the second device 104 enables content to be accessed from any of the source devices 108 through 114 by a user utilizing the second device 104 as well as controlled by the second device 104. The second device is suitably configured to output the content to the user utilizing a speaker, a display screen, an interface for an external display screen, a jack, appropriate connectivity cabling, etc.

A source device is any device that is capable of providing a source of information, such as a signal (information signal) containing music or pictures in analog or digital form. Some examples of source devices are, but are not limited to, a cable box, a set-top box, a satellite television receiver, a computer, a radio, a television, a DVD (known as a digital versatile disk or a digital video disk), a video cassette recorder, a camcorder, a digital camera, an audio player (analog or digital, such as MP3 players), and any device configured to provide a source of audio, video or audio and video information. Those of skill in the art will appreciate that “set-top box” can be used to refer to a variety of boxes used to house electronics (switches, receivers, tuners, demodulators, etc.) that are used in conjunction with a television monitor, such “set-top boxes” can include, but are not limited to, cable television boxes, satellite television receivers, high-definition television receivers, etc. In various embodiments, when a source device, such as any of 108 through 114, outputs an analog signal, analog to digital (A/D) conversion is provided for the signal. A/D conversion can be provided anywhere along a path from a source device's analog output to within a device connected thereto, such as the first device 102. Some examples of A/D conversion within the device 102 utilizing electronics configured to accept an analog signal and to convert the analog signal to a digital signal are, but are not limited to, an Accelerated Graphics Port (AGP) card, a Peripheral Component Interconnect (PCI) card, a Peripheral Component Interconnect Express (PCI-E) card, a built-in video card, etc.

In various embodiments, a user uses the second device 104 to control one or more of the source devices 108 through 114, thereby receiving digital content on the second device 104. Alternatively, a source device 120 can be resident within the first device 102. When a source device is resident within (internal to) the first device 102, such as the source device 120, control of the source device 120 is accomplished with the host device's (in this example, the first device 102's) operating system, bus, and a native software device driver for the source device 120. Content resident on the internal source device 120 can be accessed remotely by the second device 104 utilizing virtual content directories, which are described below in conjunction with the figures that follow.

As mentioned above, a source device can be a device such as a cable box, a set-top box, a satellite television receiver, a computer, a radio, a television, a DVD (known as a digital versatile disk or a digital video disk), a video cassette recorder, a camcorder, a digital camera, an audio player (analog or digital, such as MP3 players), any device configured to provide a source of audio, video or audio and video information, etc. In such cases, the content (audio, video, and digital images, etc.) is converted to digital form for efficient storage and transmission from the first device 102 to the second device 104 over the network 106. In various embodiments, the source of information is encoded with an encoder 122, transmitted over the network 106 and decoded by a decoder 124 on the second device 104. The term “streaming audio” or “streaming video,” as applied to stored content, is used broadly to describe a process of sending the corresponding information (audio, video or audio/video) from point A to point B, such as the first device 102 to the second device 104, so that a user can hear or see the content before the entire content is transferred from point A to point B. Thus, a user of the second device 104 receives streaming audio and or video on the second device 104.

The encoder 122 can be a commercially available encoder, such as the Microsoft Windows Media® Encoder, the Real Server®, or any application configured to encode digital content. Similarly, the decoder 126 or 124 can be a commercially available decoder, such as the Microsoft Windows Media® Player, the Real Player®, or any application configured to decode digital content.

In various embodiments, the network 106 is an Internet Protocol (IP) based network. Such an IP network permits the two devices (102 and 104) to reside on any type of network supporting IP, such as the Internet, an intranet, a Wide Area Network, a Metropolitan Area Network, Local Area Network, Personal Area Network, a cellular telephone network, or any combination thereof, providing that each device can successfully reach one another. For example, the network 106 can be an intranet, a local area network, a cellular telephone network that supports IP, etc. In other embodiments, the network 106 can be a dedicated network that is configured to provide access between the first device 102 and the second device 104.

FIG. 1B shows device architectures according to various embodiments of the invention, generally at 150. With reference to FIG. 1B, a first device 152 contains a processor 170, a memory 172, a network interface 174 and a source device control 176. A second device 154 is coupled to the first device using a network 156. The second device 154 includes a processor 180, a memory 182, and a network interface 184.

The first device 152 communicates with a source device 158 using a path 160. Content can flow from the source device 158 to the first device using a path 162. Source devices, such as the source device 158, can be configured with a single path or multiple paths, such as 162. For example, the source device 158 can be configured to communicate over the path 162 using a coaxial cable, an analog video output (RCA cable), a super video (S-video) cable, a composite video output, a universal serial bus (USB), a fire-wire (IEEE-1394), etc., or any combination thereof. Alternatively, paths 160 and 162 can represent a communication path such as USB, fire-wire, etc.

In various embodiments, the path 160 can be wired or wireless. In one embodiment, the communication path is a wireless communication path that is configured to use a signal in an infra-red portion of the electromagnetic spectrum. In one or more embodiments, the source device control 176 includes an infra-red emitter that is used to transmit commands to the source device 158. In one or more embodiments, the source device control 176 is a SMARTHOME™ PC to IR Link device.

The first device 152 or 102 (FIG. 1A) can be, in various embodiments, a personal computer, a laptop computer, a personal digital assistant, a tablet computer, a cellular telephone, a satellite telephone, a wireless computing device, a general purpose data processing machine, etc. Those of skill in the art will appreciate that in some embodiments, the source device control 176 is a built-in infra-red interface of a laptop computer, PDA, tablet computer, etc.

In various embodiments, the second device 154 can utilize a wireless connection 186 with the network 156, where the wireless connection 186 to the network 156 is made to facilitate communication with the first device 152. In one or more embodiments, the second device 154 can be enabled for wireless Internet communication utilizing the IEEE 802.11a, IEEE 802.11b, IEEE 802.11X, IEEE 802.15 (Bluetooth) standards (originating in the United States), as well as the HiperLAN standards (originating in Europe) or other wireless communication standards that permit wireless communication by devices.

Similarly, the first device 152 can utilize a wireless connection 190 with the network 156, where a wireless connection 190 to the network 156 is made to facilitate communication with the second device 154. In one or more embodiments, the first device 152 can be enabled for wireless Internet communication utilizing the IEEE 802.11a, IEEE 802.11b, IEEE 802.11X, IEEE 802.15 (Bluetooth) standards (originating in the United States), as well as the HiperLAN standards (originating in Europe) or other wireless communication standards that permit wireless communication by devices.

The second device 154 can be in various embodiments; a personal computer, a laptop computer, an Internet enabled telephone, a satellite telephone, a personal digital assistant (PDA), a tablet computer, a wireless computing device, a general purpose data processing machine, etc.

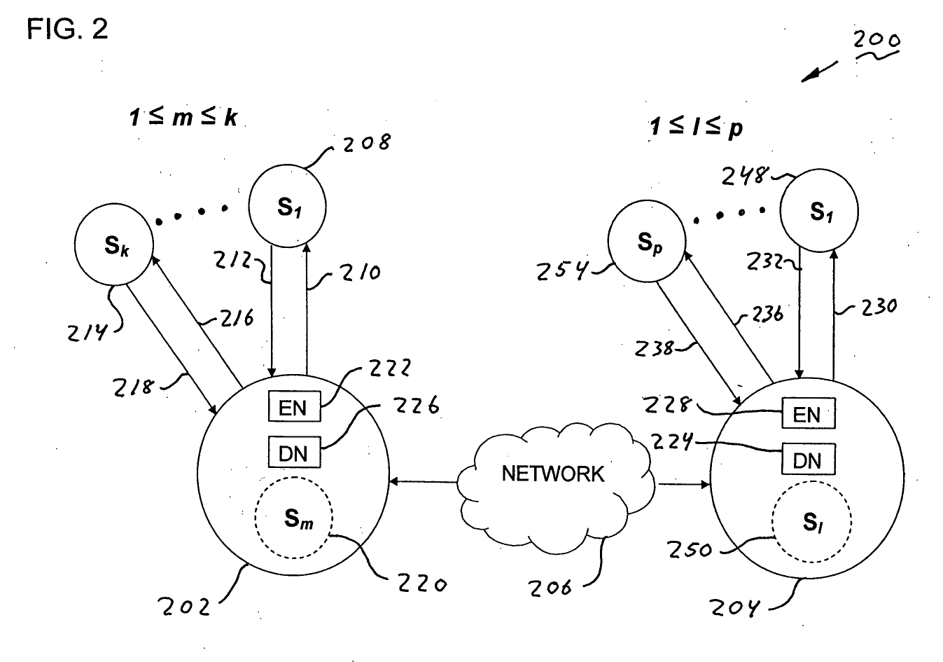

FIG. 2 illustrates a symmetric architecture for delivery of digital content, according to one embodiment of the invention, generally at 200. With reference to FIG. 2, a first device 202 is in communication with a second device 204 through a network 206. Utilizing an architecture that includes a processor, a memory, a network interface, and a source device control (which, in one embodiment, is similar to the architecture described in FIG. 1B for the first device 152); a general number (k) of source devices 208 through 214 provides sources of content to the first device 202. The source device 208 receives control signals across a path 210 and content from the source device 208 can travel to the first device 202 along a path 212. Similarly, the source device 214 receives control signals across a path 216 and content from the source device 214 can travel to the first device 202 along a path 218. An encoder 222 and a decoder 226 are configured for operation by a user utilizing the processor, the memory, and a suitable user interface.

A second device 204 is configured similarly to the first device 202. Utilizing an architecture that includes a processor, a memory, a network interface and a source device control (which, in one embodiment, is similar to the architecture described in FIG. 1B for the first device 152); a general number (p) of source devices 248 through 254 provides sources of content to the second device 204. The source device 248 receives control signals across a path 230 and content from the source device 248 can travel to the second device 204 along a path 232. Similarly, the source device 254 receives control signals across a path 236 and content from the source device 254 can travel to the second device 204 along a path 238. An encoder 228 and a decoder 224 are configured for operation by a user utilizing the processor, the memory, and a suitable user interface.

One or more optional source devices can be attached to the first device 202 as indicated at 220. Similarly, one or more optional source devices can be configured within the second device 204 as indicated at 250.

Both the first device 202 and the second device 204 can be configured with a variety of user interfaces to allow a user to control the source devices attached thereto. For example, in a one embodiment, the user interface is an information display, such as a computer monitor, that receives input through a pointing device such as a mouse, a keyboard, joystick, pushbutton or lever control, voice command, microphone, etc. In another embodiment, a wireless remote control is used in conjunction with a wireless receiver and an information display to allow input by a user. In yet another embodiment, the user interface is a screen with a built-in touch pad for receiving input from the user on the same interface that displays a visual output containing the result of the decoded streaming video and/or audio.

The architecture of FIG. 2, allows the device 202 to control any of the source devices 208, 214, 220, 248, 254 or 250. Similarly, the second device 204 can control any of the source devices, 208, 214, 220, 248, 254 or 250. Such a configuration allows a user to access content from any source device, e.g. 202 or 204.

The first device 202 and the second device 204 can be, in various embodiments, a personal computer, a laptop computer, a personal digital assistant, a tablet computer, a cellular telephone, a satellite telephone, a wireless computing device, a general purpose data processing machine, etc. Those of skill in the art will appreciate that in some embodiments, the source device control, configured with the device 202 and/or the device 204, is a built-in infra-red interface of a laptop computer, PDA, tablet computer, etc. Both the first and second device 202 and 204 can be configured for wireless communication, as was described above in conjunction with the devices in the preceding figures.

The architecture of FIG. 2 can be extended to accommodate additional devices, such as a third device, a fourth device (not shown), etc; thereby allowing a user to access content from a variety of devices located in a variety of places. For example, a first device, such as the device 202, can be located in a user's home. A second device, such as the device 204, can be located in a user's office, and a third device (not shown but similar to either of devices 202 or 204) could be located in a user's vehicle (car, truck, camper, bus, plane, etc.).

In yet other embodiments, a device such as the device 104 (FIG. 1A) or the device 154 (FIG. 1B) can be configured with the system of FIG. 2 to allow a user to access sources of content accordingly. In one example, a device such as the device 104 (FIG. 1A) can be transported with a user, thus allowing the user to access content while the user is in transit to work (on a bus for example), while the device 202 is located in the user's home and the device 204 is located in the user's office. In this example, the user could be watching the news on a television in the user's home, while at home eating breakfast, and then continue to watch the news on a second device, which obtains the content from the television at home, while the user is in transit to work.

It will be appreciated that embodiments of the present invention are not limited to the specific examples or locations of devices given in the examples presented within this description of embodiments. The examples of embodiments presented are provided for illustration only and do not limit embodiments of the invention.

It will be appreciated that a user can access content, originating from a source device, simultaneously on a number of devices, such as a plurality of second devices. For example, the device 202, the source device 208, and the encoder 222 can be configured to stream content to the second device 204 as well as a number of other devices (not shown), such as described in the example of the paragraph above. Alternatively, a number of different users can receive content on a number of devices; however, it will be noted that control of a source device will be reflected in the content received by all the users, since all the users receive the same content originating from the source device.

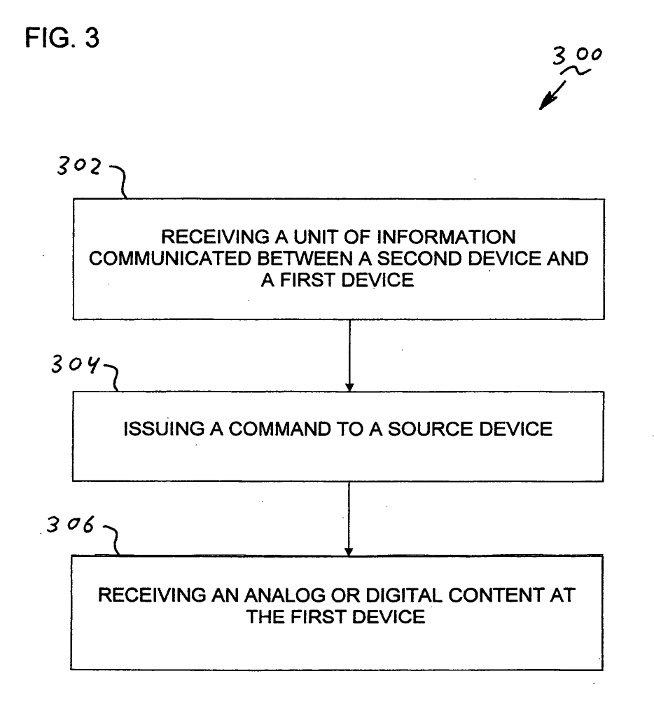

FIG. 3 depicts a process to control a source device, according to embodiments of the invention, generally at 300. With reference to FIG. 3, in one embodiment at block 302 a unit of information is received at a first device in response to a user interaction with a second device. Such a process is accomplished with suitable application software and hardware architecture as shown in the previous figures. At block 304 a command is sent to a source device in response to the unit of information received by the first device. At block 306 an analog or digital signal (information signal or content) is received at the first device in response to the command issued at block 304. It should be noted that a source device can be outputting an analog or digital signal (in a continuous fashion) and the command sent at block 304 can cause an action to be taken with respect to the signal, such as a command to instruct an encoder to start encoding the signal available at its input.

In one embodiment, a software application is configured for use on an Internet Protocol (IP) based network by a first device; the software application is referred to herein as the first application. The first device, such as the device 102 (FIG. 1A), etc. can also be configured to function as a web server. The first device can perform the web server function by being configured with Internet Information Services from Microsoft®, Apache, etc. or the first device can run other software to perform the web server function. The first device has associated therewith, a user-defined IP address on a user-defined IP port, which allows for connection with a second device, such as the device 104 (FIG. 1A), etc., utilizing an IP network.

The first device is further configured with an encoder and optional decoder as described above. The encoder can be a commercially available encoder, such as the Microsoft Windows Media® Encoder, the Real Server®, or any application configured to encode digital content. The first device provides the service of encoding any audio, video, or audio and video stream from any source device connected thereto. The digital stream is broadcast to the IP port and address described above for transmission to the second device utilizing the IP network.

In yet other embodiments, the first device, such as the device 102, (FIG. 1A) need not be configured as a web server. A second device, such as the device 104 (FIG. 1A) can be configured with a web based version of a decoder in an application that runs on the second device (second application described more fully below). Alternatively, a non-web based decoder can be configured to run as a stand alone application outside of the web based browser's (second application's) window. In yet other embodiments, the first device and the second device can be configured without an Internet connection, such as when the devices communicate on a dedicated network or in other cases when the first and the second applications run on a single device such as the first device 102 (FIG. 1A).

As described above, a source device includes, but is not limited to, a cable box, a set-top box, a satellite television receiver, a computer, a radio, a television, a DVD (known as a digital versatile disk or a digital video disk), a video cassette recorder, a camcorder, a digital camera, an audio player (analog or digital, such as MP3 players), and any device configured to provide a source of audio, video or audio and video information. Also, as described above, these devices can be connected to the first device by ways which include, but are not limited to, a coaxial cable, S-Video, Composite video, USB, fire-wire, etc. Such connections to the first device can include an appropriate integration device, such as but not limited to: a PCI interface card, PCI-Express interface card, switch boxes (providing a conversion of connector formats), a VIVO cable used in conjunction with a PCI or PCI express or AGP interface card.

The first application is further configured to allow the user to create encoder profiles which are used in conjunction with the source devices that are connected with the first device. Encoder profiles are used to set parameters associated with the encoding process. Such parameters can include which source to use for video if any, which input source to use for audio if any, customizations of the encoding process, which HTTP port to broadcast on, a bit rate at which to encode the audio and/or video, how many recipients of the broadcast to allow, security, etc. Security can include regulating which users and/or devices are allowed to access and control content.

The first application is further configured to allow the user to create encoder profiles which are used to control the source devices that are in communication with the first device. Encoder profiles can also be created using the second application (described below). A control profile defines a group of commands that can be used to allow a source device control, such as the source device control 176 (FIG. 1B), to send a corresponding signal to a source device, by way of a path, such as the path 110 (FIG. 1A), for example. The control profile also associates appropriate components of a user interface (part of the second application described below), used on the second device or the first device, with the commands, thereby enabling a user to control the source device from the second device or the first device utilizing the user interface. It will be noted, as mentioned above, that the second application, described below in conjunction with the second device, can also reside on the first device, thereby allowing a user the ability to control a source device from either of a first device or a second device.

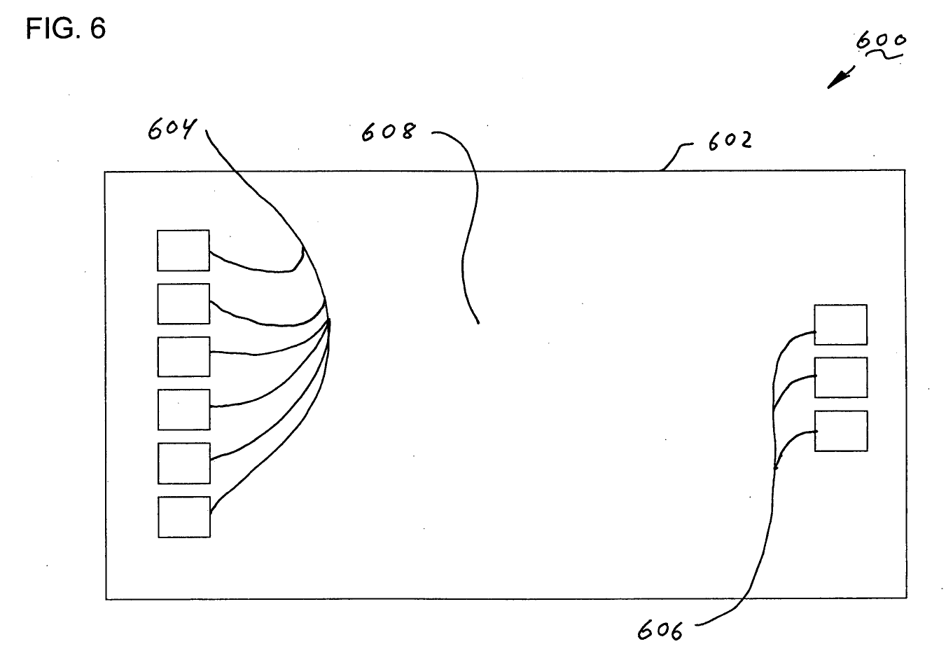

Examples of commands are, but are not limited to: Channel Up, Channel Down, Program Guide, Power On, Power Off, etc. The signals that are sent from a source device control are tailored to a particular device and can be sent along a wireless path or on a wired path. In some embodiments, the signals are sent as infra-red (IR) signals. In some embodiments, a SMARTHOME™ PC to IR Linc device is used to send the signals to the source device. The user interface can be configured with buttons, etc.; one embodiment of a user interface is described below in conjunction with FIG. 6. Alternatively, or in addition to controlling the source device from the second device, the source device can be controlled from a user interface associated with the first device.

The first application is further configured to provide the service of enabling the user to create virtual content directories. A virtual content directory is associated with a physical path to static content that is available on a networked or a source device. For example, a user of either the first or second device can select from one or more virtual content directories, content to receive on either the first or the second device, respectively. It will be appreciated by those of skill in the art that the first application can be used by more than two devices, as described above in conjunction with the preceding figures; therefore, a user is not limited to select or use only two devices. It will be understood that two devices are used to provide clarity in this discussion; however, no limitation is implied thereby.

In one embodiment, an application configured for use by a second device, such as the device 104 (FIG. 1A) or 154 (FIG. 1B), is referred to herein as the second application. In various embodiments, the second application is configured to connect to the first device using a web browser. In one embodiment, a web browser supports HTML 4.0 and embeds a playback device's (decoder's) object code within its markup language. Such functionality allows the decoder to reside within a web page. In other embodiments, the decoder will be configured to operate outside of the web browser configured on the second device. In various embodiments, the decoder is the decoder 126 or 124 (FIG. 1A) and can be a commercially available decoder, such as the Microsoft Windows Media® Player, the Real Player®, or any application configured to decode digital content.

Security can be provided to prevent unauthorized users from accessing content on a device. For example, security can be provided to a first device, such as for example the first device 102 (FIG. 1A), by utilizing authentication protocols, such as a username (a user ID) and password that permit a user to log onto a server, etc. In other cases security can be provided by authenticating a client device, such as for example the second device 104 (FIG. 1A), with a form of identification, such a serial number, an IP address, etc.

The second application is further configured to select and employ previously configured profiles within a web browser. For example, the second application is configured to select previously configured encoder profiles, previously configured control profiles, and virtual content directories of static content and to present this information to a user through a user interface. Utilizing a selected encoder profile, the second application provides the service of streaming digital content between the output of the encoder, through the port and IP address of the first device, to the decoder on the second device for playback to the user.

It will be noted that while the functionality of the applications has been described with respect to a first application and a second application, no limitation is implied. For example, functionality of the first application and functionality of the second application can be combined into a single application that runs on a device such as the device 202 (FIG. 2) or the device 204 (FIG. 2). Those of skill in the art will recognize that this flexibility applies to a web based application, as previously described, as well as to a Java applet program within a web page, etc. In some instances, a device may have limitations with respect to its ability to control a source device. In such a case, the device will not be able to support all of the functionality described herein for a given application; therefore, a first and second application have been described for use in some embodiments.

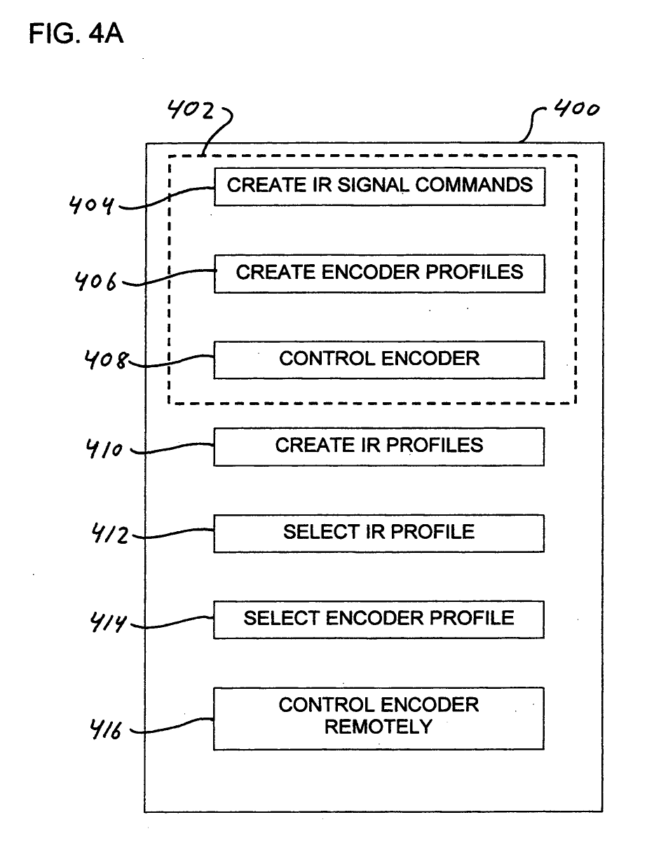

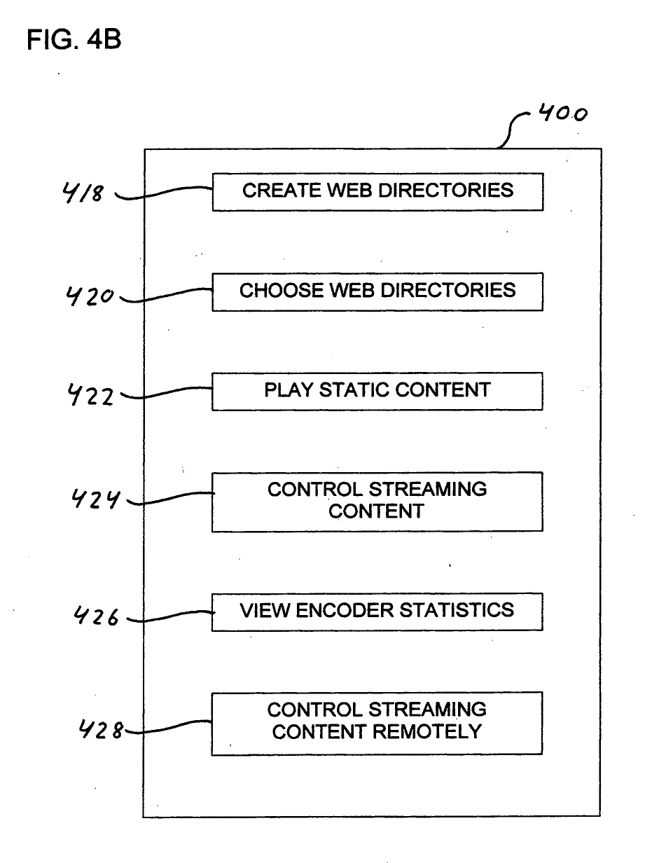

FIG. 4A depicts various functionalities of the user interfaces, according to embodiments of the invention, generally at 400. With reference to FIG. 4A, a level of functionality described above, that is particular to a first device when the first device has associated therewith a source device, is indicated by a grouping 402, which includes blocks 404, 406 and 408.

In one embodiment, a wireless interface unit is used to send commands to a source device, such as a wireless interface unit employing infra-red (IR) signals between two devices along a path. In one embodiment, at the block 404, resident in the first application, a user selects a “Create IR File” option from a menu on the user interface and either selects a predefined IR signal based on a source device or allows a new IR signal to be learned. Utilizing an IR emitter to emit the new IR signal that will be learned, the user engages the emitter, thereby allowing the new IR signal to be emitted and captured by an associated IR receiver that is part of the wireless interface unit. The user can save the new IR signal code to a command file where it can be used to generate a control profile. In various embodiments, the first application can be integrated with an existing IR interface, by utilizing the IR interface unit's drivers or application hooks or an interface unit can be customized to the first application.

At block 406 the user creates an encoder profile that is used to control the operation of the encoder. The user selects a “Create Encoder Profile” option from a menu on the user interface. The user interface is configured to permit the user to adjust parameters such as but not limited to: what device to stream from, whether to save the stream to a file, what quality of video to broadcast, what quality of audio to broadcast, what IP port to broadcast out to, etc. The user can save the encoder profile for later use. In various embodiments, the first application can be integrated with an encoder by utilizing the encoder's application hooks or an encoder can be customized to the first application.

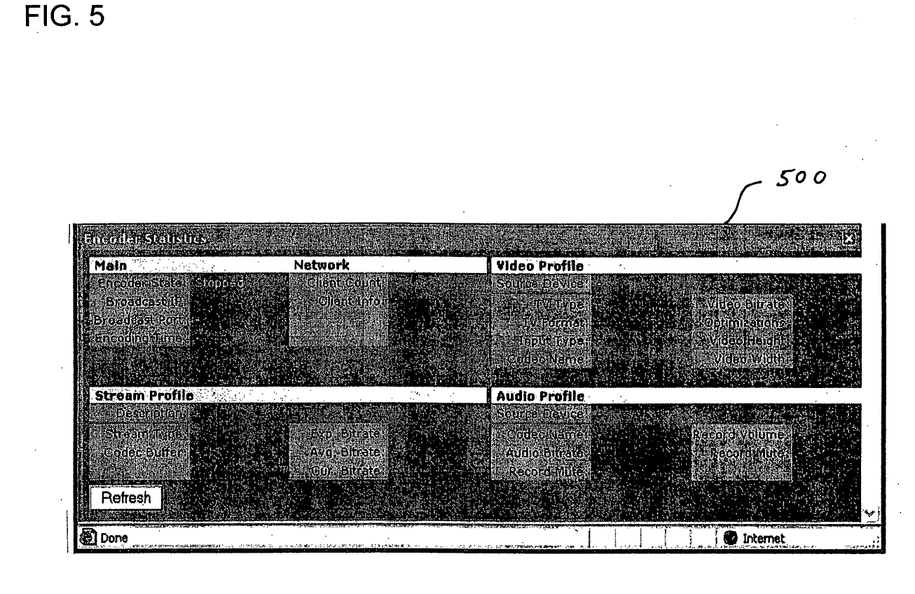

At block 408, the user can control the operation of an encoder. The user can select a “Start” option to place the encoder in an active state, which allows content to be streamed based on the previously selected encoder profile. The state of the encoder can be checked by reviewing the state indicators which are accessible from the user interface, as shown below in conjunction with FIG. 5. Alternatively, the user can select “Stop” from the user interface to halt the encoder from streaming content according the currently active encoder profile.

At block 410 the user can select a “Create IR Profile” option from a menu of the user interface. The user is presented with a list of previously created IR files. The user selects a previously created IR file from the list and assigns “identification indicia” which will appear on a user interface. One form of identification indicia is a label for a button that can be selected with a pointing device, such as a mouse, stylus, etc. Another kind of identification indicia is a text message that is posted to the user interface. The text message can inform a user about a voice command that can trigger a desired control result, such as “Channel Up,” etc. The user would speak the words “channel up” and a voice recognition routine would interpret the user's speech and perform the same functionality as depressing a button on the user interface that was labeled “Channel Up.” A “Create” selection creates a button, in one embodiment, that is coupled to the IR file previously selected. The preceding process can be repeated to create additional buttons to provide a level of control that is desired for a given source device. The IR profile can be saved to file or edited as desired.

At block 412 an IR profile is selected for use by the user on the user interface of a device, such as the first device or the second device. The user selects “Engage IR Profile” from a menu of the user interface. Previously created IR profiles are displayed from which the user selects an IR profile to load into the user interface. The selected IR profile updates the user interface with functionality that can be used to control the source devices connected with the first device.

At block 414 an encoder profile is selected for use by the user on the user interface of a device, such as the first device or the second device. The user selects “Engage Encoder Profile” from a menu of the user interface. Previously created encoder profiles are displayed, from which list the user selects an encoder profile. The selected encoder profile becomes active and is used to control the encoder.

At block 416, the user can control an encoder remotely; for example, from a second device. The user, using a menu of the user interface, selects an “Engage Encoder” option or a “Disengage Encoder” option. In one embodiment, the service supporting the encoder sits in a constant loop timer, watching for a value within a flag file that triggers starting the encoder. If the file contains a “1,” the encoder starts; if the file contains a “0,” the encoder stops. A unit of information, e.g., a “1” or a “0,” is passed from the second device to the first device using the web based architecture described herein to allow the user to control the encoder remotely (start or stop the encoder). In one embodiment, selection of an “Engage Encoder” option, from the user interface, causes a unit of information, such as a “1” to be passed from the second device to the first device, which will cause the encoder to start. Selection of a “Disengage Encoder” option, from the user interface, causes a unit of information, such as a “0” to be passed from the second device to the first device, which will cause the encoder to stop. It will be noted that units of information, such as a “1” or “0” etc. are known by those of skill in the art as data, data values, bits, etc.

FIG. 4B is a continuation of FIG. 4A. With reference to FIG. 4B, a user can manage virtual content directories (web directories) at a block 418. Previously created virtual content directories can be selected; deleted or new virtual content directories can be created. A virtual content directory can be modified or created by mapping a physical path to content residing on any accessible networked device or source device to the virtual content directory that is accessible to the first device, in the current example. It will be noted that, as previously explained, a plurality of devices can be configured within embodiments of the present invention to allow a user to access content residing on the source devices or internal source devices, associated with the plurality of devices, by means of virtual content directories.

At block 420, the user can browse through a virtual content directory (web directory) and make a selection therefrom. The user selects a virtual content directory and then a web page, which is used for playing static content, is updated with all of the content entries from the physical directory to which the virtual content directory points. As the web page loads with the directory content entries, each of the content entries is coded with an HTTP path associated with a respective content entry, thereafter to be loaded into the decoder when the selected content entry is triggered for use.

At block 422, the user can choose to play the static content from the web directory (virtual content directory) selected at block 420. A content item is selected from the list and the decoder either streams the audio and/or video or displays a picture file depending on the type of content selected.

At block 424, the user can play the selected streamed content by selecting “Play Encoder Content” from a menu of the user interface. The previously selected IR profile is selected for use.

It will be noted that static content can be passed between two devices in other ways (blocks 420 and 422). For example, in various embodiments, static content, selected by means of a virtual content directory, can be input into an encoder (associated with a first device) and then streamed to a decoder associated with a second device and then provided to a user.

At block 426, the user can view the encoder statistics. In one embodiment, a status monitor for an encoder is illustrated in FIG. 5 at 500. By selecting “Encoder Statistics,” from a menu of the user interface, the user can view the current encoder settings in use from the status monitor 500.

At block 428, the user can control the content that is received from a source device by remotely sending a unit of information to the first device which causes a command to be sent to a source device. In one embodiment, the user selects an option from a menu of the user interface “Play Encoder Content.” This selection causes the previously selected IR profile to be loaded into the user interface. If acceptable to the user, the user can proceed by selecting “Encoder Statistics” from the menu and then select “View Broadcast” from the menu. Selecting “View Broadcast” causes the embedded decoder to connect to the broadcast IP address and port of the encoder; effectively joining the stream currently broadcast to the first device's IP address and port. A user interface, corresponding to the web interface, is illustrated in FIG. 6. With reference to FIG. 6, a user interface is illustrated generally at 600. The user interface includes a main region 602, which can occupy all of or a portion of a device's display screen and a viewing portion 608, on which the content is displayed for viewing by the user.

Within the main region 602 is a number of identification indicia associated with the currently selected IR profile, indicated at 604. The user can select from any of the identification indicia, e.g., buttons, voice commands, etc. which causes the execution of the associated IR signal file on the first device. The associated IR signal file, when sent to the IR emitter of the IR interface unit, causes the IR emitter to broadcast an IR command to the source device. Such commands cause the source device to perform accordingly, such as change channels, etc., thereby causing a change in the content that is output from the source device.

A number of identification indicia 606 are provided that allow the user to control aspects of the media content transfer process, such as but not limited to, engage encoder, disengage encoder, etc. It will be noted by those of skill in the art that the user interface 600 can be configured in different ways and is not limited to the arrangement shown in FIG. 6.

It will be appreciated that the division of functionality between a first device, having attached thereto one or more source devices, and a second device results in passing one or more units of information or data between the first device and the second device in response to a selection made by a user. For example, a user makes a selection using a user interface on a second device and with a pointing device presses a button or issues a voice command. Such a selection results in a unit of information passing to another device, such as the first device that can function as a web server. The unit of information can cause a result such as issuance of a command to a source device. The source device can respond, as described above, and send content to the second device in reply.

It will also be noted that the unit of information can be referred to as a data bit, a data value, data or similar expressions. It is understood by those of skill in the art that such terms can be used synonymously when describing such quantities and that no limitation is implied by the use of one term over another.

For purposes of discussing and understanding the embodiments of the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases mean that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
initiating a network connection between a first device and a second device; and
transmitting a unit of information from the second device to the first device, utilizing the network connection for the transmitting, wherein the unit of information is used to control a source device, wherein the source device is in communication with the first device.

2. The method of claim 1, further comprising:
receiving a digital content at the second device, wherein the receiving is responsive to the transmitting and the digital content originated as an information signal from the source device.

3. The method of claim 2, further comprising:
utilizing wireless communication between the first device and the source device to control the source device.

4. The method of claim 3, wherein the wireless communication utilizes a signal in the infra-red portion of the electromagnetic spectrum.

5. The method of claim 2, wherein control of the source device causes a change in the digital content and the first device does not have a driver for the source device.

6. The method of claim 3, further comprising;
managing a virtual content directory.

7. The method of claim 2, further comprising:
transmitting a second unit of information from the second device to the first device, utilizing the network connection for the transmitting the second unit, wherein the second unit of information is used to control an encoder, the encoder is configured to encode the analog or digital content.

8. The method of claim 2, further comprising:
decoding the digital content.

9. The method of claim 8, wherein the decoding can be performed on and controlled from the first device or the second device.

10. The method of claim 2, wherein the first device is selected from the group consisting of a personal computer, a laptop computer, a personal digital assistant (PDA), a tablet computer, a cellular telephone, a satellite telephone, a wireless computing device, and a general purpose data processing machine.

11. The method of claim 2, wherein the second device is selected from the group consisting of a personal computer, a laptop computer, a personal digital assistant (PDA), a tablet computer, a cellular telephone, a satellite telephone, a wireless computing device, and a general purpose data processing machine.

12. The method of claim 2, wherein the source device is selected from the group consisting of a cable box, a set-top box, a satellite television receiver, a radio, a television, a DVD, a video cassette recorder, a camcorder, a video camera, a digital camera, an audio player, a device configured to provide audio information, a device configured to provide video information, a device configured to produce audio/video information, a device configured to provide digital content wherein the device is configured with an infrared control, and a device configured to provide analog content wherein the device is configured with an infrared control.

13. The method of claim 2, wherein the digital content is selected from the group consisting of streaming audio, streaming video, and streaming audio/video.

14. The method of claim 2, wherein a network coupled to the network connection is selected from the group consisting of the Internet, an intranet, a Wide Area Network, a Metropolitan Area Network, a Local Area Network, a Personal Area Network, a cellular telephone network, and a dedicated network.

15. A method comprising:
initiating a network connection between a first device and a second device, wherein a source device is in communication with the first device and the first device does not have a device driver for the source device;
controlling the source device from the second device, wherein an information signal is sent from a source device to the first device, responsive to the controlling;
encoding the information signal from the source device on the first device to form an encoded signal; and
decoding the encoded signal on the second device.

16. The method of claim 15, further comprising:
utilizing wireless communication between the first device and the source device to control the source device, wherein the wireless communication utilizes a signal in an infra-red portion of the electromagnetic spectrum.

17. The method of claim 16, wherein the first device is selected from the group consisting of a personal computer, a laptop computer, a personal digital assistant (PDA), a tablet computer, a cellular telephone, a satellite telephone, a wireless computing device, and a general purpose data processing machine.

18. The method of claim 16, wherein the second device is selected from the group consisting of a personal computer, a laptop computer, a personal digital assistant (PDA), a tablet computer, a cellular telephone, a satellite telephone, a wireless computing device, and a general purpose data processing machine.

19. The method of claim 16, wherein the source device is selected from the group consisting of a cable box, a set-top box, a satellite television receiver, a radio, a television, a DVD, a video cassette recorder, a camcorder, a video camera, a digital camera, an audio player, a device configured to provide audio information, a device configured to provide video information, a device configured to produce audio/video information, a device configured to provide digital content wherein the device is configured with an infrared control, and a device configured to provide analog content wherein the device is configured with an infrared control.

20. The method of claim 18, further comprising:
controlling the encoding from the second device.

21. A method comprising:
receiving at a first device, a unit of information from a second device, wherein the first device and the second device are in communication over a network;
issuing a command to a source device, responsive to the receiving; and
receiving an information signal at the first device responsive to the issuing.

22. The method of claim 21, further comprising;
creating a second command that can be sent to a source device.

23. The method of claim 21, further comprising:
utilizing wireless communication between the first device and the source device to control the source device.

24. The method of claim 23, wherein the wireless communication utilizes a signal in an infra-red portion of the electromagnetic spectrum.

25. The method of claim 24, further comprising;
learning an infra-red command, wherein the infra-red command is used to control the source device.

26. The method of claim 23, wherein the first device is selected from the group consisting of a personal computer, a laptop computer, a personal digital assistant (PDA), a tablet computer, a cellular telephone, a satellite telephone, a wireless computing device, and a general purpose data processing machine.

27. The method of claim 23, wherein the second device is selected from the group consisting of a personal computer, a laptop computer, a personal digital assistant (PDA), a tablet computer, a cellular telephone, a satellite telephone, a wireless computing device, and a general purpose data processing machine.

28. The method of claim 23, wherein the source device is selected from the group consisting of a cable box, a set-top box, a satellite television receiver, a radio, a television, a DVD, a video cassette recorder, a camcorder, a video camera, a digital camera, an audio player, a device configured to provide audio information, a device configured to provide video information, a device configured to produce audio/video information, a device configured to provide digital content wherein the device is configured with an infrared control, and a device configured to provide analog content wherein the device is configured with an infrared control.

29. An apparatus comprising:
a network interface, the network interface is configured to allow the apparatus to communicate with a first device over a network;
a storage device; and
a processor programmed to:
send data to the network interface, responsive to an input from a user, for transmission over the network to the first device; and
maintain in the storage device a digital content received from the first device.

30. The apparatus of claim 29, wherein the network interface is wireless.

31. The apparatus of claim 29, wherein the data is used to cause the first device to issue a command to a source device, wherein an information signal can be sent from the source device to the first device in response to the command.

32. The apparatus of claim 29, wherein the first device is selected from the group consisting of a personal computer, a laptop computer, a personal digital assistant (PDA), a tablet computer, a cellular telephone, a satellite telephone, a wireless computing device, and a general purpose data processing machine

33. The apparatus of claim 29, wherein the processor is further programmed to:
decode the digital content.

34. The apparatus claim 33, wherein the processor is programmed to decode the digital content with a decoder selected from the group consisting of Microsoft Media Player®, Real Player®, and any decoder capable of decoding an encoded digital content.

35. An apparatus comprising:
a network interface, the network interface is configured to allow the apparatus to communicate with a second device over a network;
a storage device; and
a processor programmed to:
receive data from the network interface, responsive to input from a user of the second device;
send a command to a source device, responsive to the data received from the network interface; and
maintain in the storage device digital content received from the source device.

36. The apparatus of claim 35, wherein a wireless communication utilizes a signal in an infra-red portion of the electromagnetic spectrum to send the command to the source device and the processor is not programmed with a driver to control the source device.

37. The apparatus of claim 36, further comprising:
an infra-red emitter, the infra-red emitter is coupled with the apparatus and can be used to send the command to the source device.

38. The apparatus of claim 37, wherein the infra-red emitter is selected from the group consisting of a SMARTHOME PC-to-IR LINK, an emitter built into the apparatus, and an emitter housed in a peripheral device.

39. The apparatus of claim 35, wherein the processor is further programmed to:
encode the digital content.

40. The apparatus claim 39, wherein the processor is programmed to encode the digital content with an encoder selected from the group consisting of Microsoft Windows Media Encoder®, Real Server®, and any encoder capable of encoding a digital content.

41. A computer readable medium containing executable computer program instructions, which when executed by a data processing system, cause the data processing system to perform a method comprising:
initiating a network connection between a first device and a second device; and
transmitting a unit of information from the second device to the first device, utilizing the network connection for the transmitting, wherein the unit of information is used to control a source device, wherein the source device is in communication with the first device and the first device does not have a device driver for the source device.

42. The computer readable medium, as set forth in claim 41, the method further comprising:
receiving a digital content at the second device, wherein the receiving is responsive to the transmitting and the digital content originated as an information signal from the source device.

43. The computer readable medium, as set forth in claim 42, the method further comprising:
utilizing wireless communication between the first device and the source device to control the source device.

44. The computer readable medium, as set forth in claim 43, wherein the wireless communication utilizes a signal in an infra-red portion of the electromagnetic spectrum.

45. The computer readable medium, as set forth in claim 42, the method further comprising:
decoding the digital content.

46. The computer readable medium, as set forth in claim 45, wherein the decoding can be performed on and controlled from the first device or the second device.

47. An apparatus comprising:
means for sending a unit of information to a first device;
means for communicating with a source device in response to the unit of information; and
means for receiving a first digital content on a second device, by way of the first device, wherein the first digital content originated as a signal from the source device.

48. The apparatus of claim 47, further comprising:
means for creating a command file, wherein the command file can be used by the means for communicating.

49. The apparatus of claim 48, further comprising;
means for selecting a second digital content from a storage location.

50. The apparatus of claim 48, wherein the first digital content is encoded on the first device to create an encoded digital content.

51. The apparatus of claim 50, further comprising:
means for decoding the encoded digital content.
